(19) United States
(12) Patent Application Publication
(10) Pub. No.: US 2026/0161380 A1
(43) Pub. Date: Jun. 11, 2026

(54) IMAGE PROCESSING APPARATUS UPDATING FIRMWARE STORED IN STORAGE DEVICE WHEN CORE NUMBER OF FIRMWARE STORED IN STORAGE DEVICE MATCHES CORE NUMBER OF UPDATE FIRMWARE AND FIRMWARE UPDATE METHOD

(71) Applicant: KYOCERA Document Solutions Inc., Osaka (JP)

(72) Inventors: Ho RI, Osaka (JP); Izumi KUZE, Osaka (JP); Yukihiro SHIBATA, Osaka (JP); Nobuyuki FUCHIMOTO, Osaka (JP); Masayuki GONDO, Osaka (JP); Masaki SONE, Osaka (JP); Takashi HARADA, Osaka (JP)

(73) Assignee: KYOCERA Document Solutions Inc., Osaka (JP)

(21) Appl. No.: 19/179,730

(22) Filed: Apr. 15, 2025

(30) Foreign Application Priority Data
Apr. 19, 2024 (JP) 2024-068694

(51) Int. Cl. G06F 8/65

(52) U.S. Cl. CPC G06F 8/65

(57) ABSTRACT

An image processing apparatus includes a storage device, a controller, and a data acquiring device. The storage device includes a plurality of partitions and stores firmware. The controller performs update of the firmware. The data acquiring device acquires update firmware. Each of the firmware and the update firmware includes a management number corresponding to a partition in which firmware associated with starting is stored as a core number. The controller compares the core number of the firmware stored in the storage device with the core number of the update firmware and performs a process of overwriting an area in which the firmware is stored in the storage device with the update firmware when both core numbers match.

### INCORPORATION BY REFERENCE This application claims priority to Japanese Patent Application No. 2024-068694 filed on 19 Apr. 2024, the entire contents of which are incorporated by reference herein.

### BACKGROUND

The present disclosure relates to an image processing apparatus and a firmware update method.

An image forming apparatus such as a multifunction machine having functions such as a scanner function, a printer function, a copier function, or a facsimile function stores firmware for controlling hardware for realizing the functions in a read only memory (ROM). The firmware stored in the ROM is updated with the newest firmware according to necessity.

In general, a first technique of updating firmware without losing setting information of an image processing apparatus is known. A second technique of updating only necessary firmware in consideration of failure avoidance of a controller board and the like is also known.

### SUMMARY

An aspect of the present disclosure proposes a technique obtained by further improving the aforementioned technique.

An image processing apparatus according to an aspect of the present disclosure includes a storage device, a controller, and a data acquiring device. The storage device includes a plurality of partitions and stores firmware. The controller includes a processor and performs update of the firmware by causing the processor to execute a control program. The data acquiring device acquires update firmware. Each of the firmware and the update firmware includes a management number corresponding to a partition in which firmware associated with starting is stored as a core number. The controller compares the core number of the firmware stored in the storage device with the core number of the update firmware and performs a process of overwriting an area in which the firmware is stored in the storage device with the update firmware when both core numbers match.

A firmware update method according to another aspect of the present disclosure includes a storage step of storing firmware in a storage device including a plurality of partitions and a data acquiring step of acquiring update firmware via a data acquiring device. Each of the firmware and the update firmware includes a management number corresponding to a partition in which firmware associated with starting is stored as a core number. The firmware update method further includes a comparison step of comparing the core number of the firmware stored in the storage device with the core number of the update firmware and an overwriting step of overwriting an area in which the firmware is stored in the storage device with the update firmware when it is determined in the comparison step that the core number of the update firmware and the core number of the firmware match.

### BRIEF DESCRIPTION OF THE DRAWINGS

FIG. 1 is a diagram illustrating an electrical configuration of an image processing apparatus.

FIGS. 2 to 6 are diagrams illustrating a partition structure of firmware.

FIG. 7 is a flowchart illustrating a flow of a firmware update process.

FIG. 8 is a diagram illustrating a data structure of a nonvolatile memory.

FIG. 9 is a diagram illustrating a display example of a display apparatus.

### DETAILED DESCRIPTION

Hereinafter, an image processing apparatus and a firmware update method according to an embodiment of the present disclosure will be described with reference to the accompanying drawings. The image processing apparatus according to the present embodiment is an image forming apparatus such as a printer or a copier or a multifunction machine having a plurality of functions such as a facsimile function or a scanner function. In the present embodiment, an image forming apparatus will be described as an example.

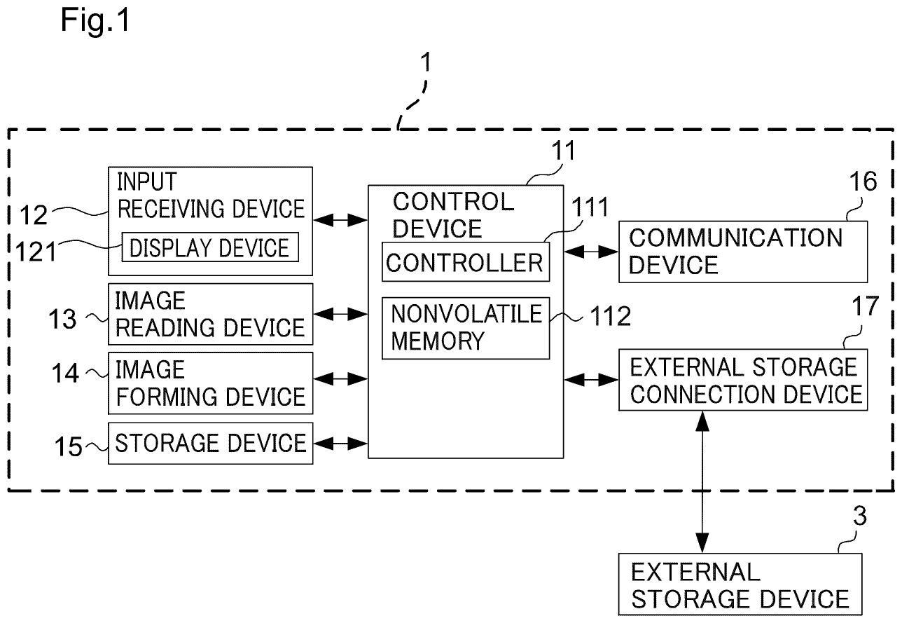

FIG. 1 is a diagram illustrating an electrical configuration of an image forming apparatus 1 according to an embodiment of the present disclosure. The image forming apparatus 1 includes a control device 11, an input receiving device 12, an image reading device 13, an image forming device 14, a storage device 15, a communication device 16, and an external storage connection device 17 (a data acquiring device).

The input receiving device 12 includes a hardware key such as a decision key for performing a confirming operation of various operations or settings or a start key and a display device 121. The input receiving device 12 receives various instructions in response to a user's operation on the keys. The display device 121 includes, for example, a liquid crystal display (LCD). The display device 121 displays an operation screen, a message, or the like. The display device 121 may include a touch panel.

The image reading device 13 includes a scanner. The image reading device 13 reads an image of an original and generates image data. The image forming device 14 includes, for example, an electrophotographic image forming mechanism. The image forming device 14 forms an image or the like indicated by image data acquired by the image reading device 13 or image data received from an external device by the communication device 16 on a sheet.

The storage device 15 is, for example, a large-capacity storage device which is constituted by an HDD and which stores image data, various programs, data tables, or the like. The storage device 15 may be constituted by a solid state drive (SSD) in addition to the HDD. The communication device 16 is constituted by a communication module or the like. The communication device 16 transmits and receives various types of data to and from an external device such as a server via a network.

The external storage connection device 17 includes an insertion port (for example, an interface such as a slot or a USB port) to which an external storage device 3 is connected. The external storage device 3 is a storage that can store a large-capacity data and is, for example, a secure digital (SD) card or a universal serial bus (USB) memory.

The external storage device 3 is set into the external storage connection device 17 for use. A controller 111 which will be described later reads various types of data from the external storage device 3 connected to the external storage connection device 17 and stores the various types of data in the storage device 15.

The control device 11 includes a processor, a random access memory (RAM), and a ROM. The processor is a central processing unit (CPU), a micro processing unit (MPU), or an application-specific integrated circuit (ASIC). The control device 11 serves as a controller 111 by causing the processor to execute a control program stored in the ROM or the like. The controller 111 controls the whole operations of the image forming apparatus 1.

The control device 11 includes a nonvolatile memory 112 (a storage device). The nonvolatile memory 112 is divided into a plurality of partitions and stores firmware for the functions of the image forming apparatus 1 such as printing or scanning in addition to firmware for starting the image forming apparatus 1.

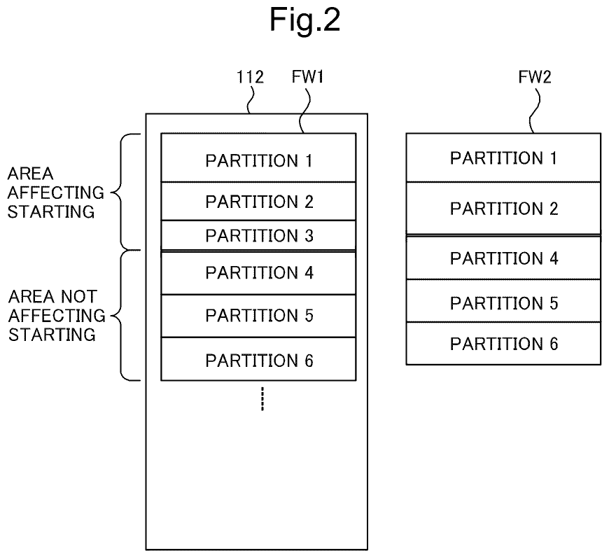

FIG. 2 is a diagram illustrating a partition structure of firmware. Firmware FW1 stored in the nonvolatile memory 112 of the image forming apparatus 1 is starting firmware which is read and executed by the controller 111 when the image forming apparatus 1 starts.

Firmware FW2 is firmware for starting the image forming apparatus 1 and is a newest version (update firmware) of the firmware FW1. The firmware FW2 is stored in the external storage device 3. When the external storage device 3 is set into the external storage connection device 17, the controller 111 reads the firmware FW2 from the external storage device 3 and performs an update process. In this case, the external storage connection device 17 is an example of a data acquiring device in the claims.

The update firmware may be acquired by causing the communication device 16 to download the update firmware from a server or the like via a network under the control of the controller 111. In this case, the communication device 16 is an example of a data acquiring device in the claims.

Here, in the firmware FW1 and FW2, it is assumed that firmware directly affecting starting of the image forming apparatus 1 is stored in Partitions 1 to 3 and firmware not affecting starting is stored in Partitions 4 to 6.

The firmware FW1 and the firmware FW2 are different in a partition structure of an area in which firmware affecting starting is stored. Accordingly, when an area in which the firmware FW1 is stored in the nonvolatile memory 112 is overwritten with the firmware FW2 through update, the image forming apparatus 1 may not start correctly.

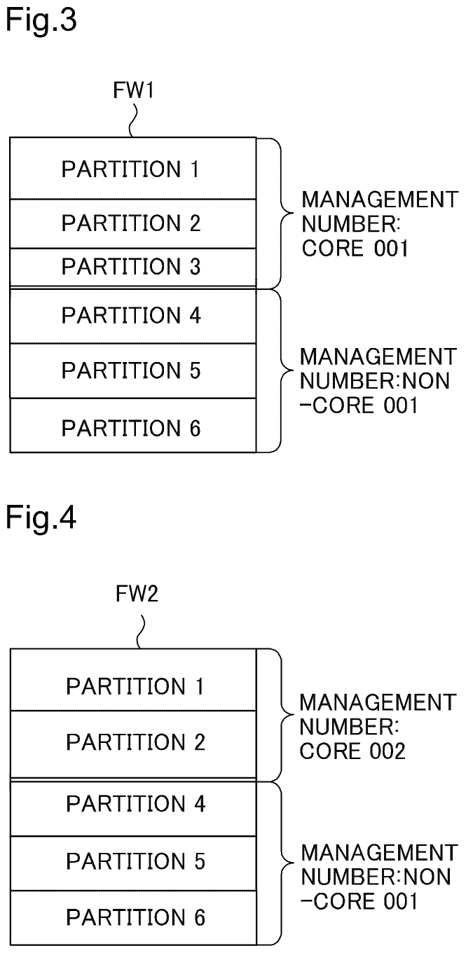

Therefore, a management number is added according to the partition structure of firmware at the time of preparation of firmware. A partition structure of the firmware FW1 is illustrated in FIG. 3. In the partition structure illustrated in FIG. 3, a management number “core 001” is added to a firmware area affecting starting, and a management number “non-core 001” is added to a firmware area not affecting starting. The management numbers are included in the firmware FW1.

A partition structure of the firmware FW2 is illustrated in FIG. 4. The partition structure of an area affecting starting in the firmware FW2 and the partition structure of an area affecting starting in the firmware FW1 illustrated in FIG. 3 are different. Accordingly, a management number “core 002” which is different from that of the firmware FW1 is added to the firmware area affecting starting in the firmware FW2. The management numbers are included in the firmware FW2.

On the other hand, the partition structure of an area not affecting starting in the firmware FW2 is the same as that of the firmware FW1, and thus the same management number “non-core 001” is added thereto.

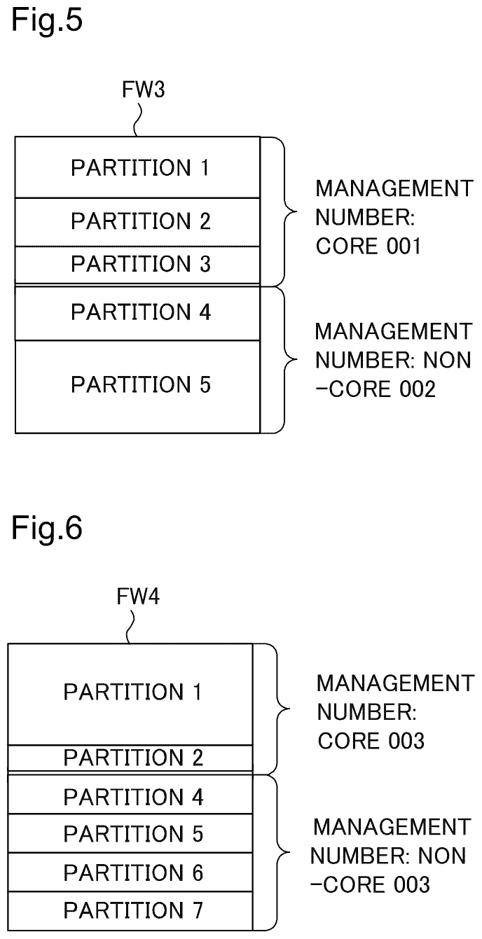

A partition structure of firmware FW3 is illustrated in FIG. 5. The partition structure of an area affecting starting in the firmware FW3 is the same as the partition structure of an area affecting starting in the firmware FW1 illustrated in FIG. 3, and thus the same management number “core 001” is added thereto.

On the other hand, the partition structure of an area not affecting starting in the firmware FW3 is different from that of the firmware FW1, and thus a management number “non-core 002” is added to the area not affecting starting in the firmware FW3. The management numbers are included in the firmware FW3.

A partition structure of firmware FW4 is illustrated in FIG. 6. The partition structure of an area affecting starting in the firmware FW4 is different from the partition structures of the firmware FW1 to FW3, and thus a management number “core 003” is added thereto. The partition structure of an area not affecting starting in the firmware FW4 is different from the partition structures of the firmware FW1 to FW3, and thus a management number “non-core 003” is added thereto. The management numbers are included in the firmware FW4.

In this way, the management numbers are added according to the partition structure of an area affecting starting of the image forming apparatus 1 in the firmware and the partition structure of an area not affecting starting, and the management numbers included therein are compared when firmware currently stored in the nonvolatile memory 112 is updated with newest firmware. When the management numbers are the same, it means that the partition structures thereof are the same, and thus no problem occurs in starting of the image forming apparatus 1 even when update with newest firmware is performed.

On the other hand, when the management numbers are different, the partition structures of firmware are different, and thus there is a likelihood that the image forming apparatus 1 will not operate normally when update with newest firmware is performed.

Accordingly, by not performing update in this case, it is possible to avoid update with details which are not intended by a user.

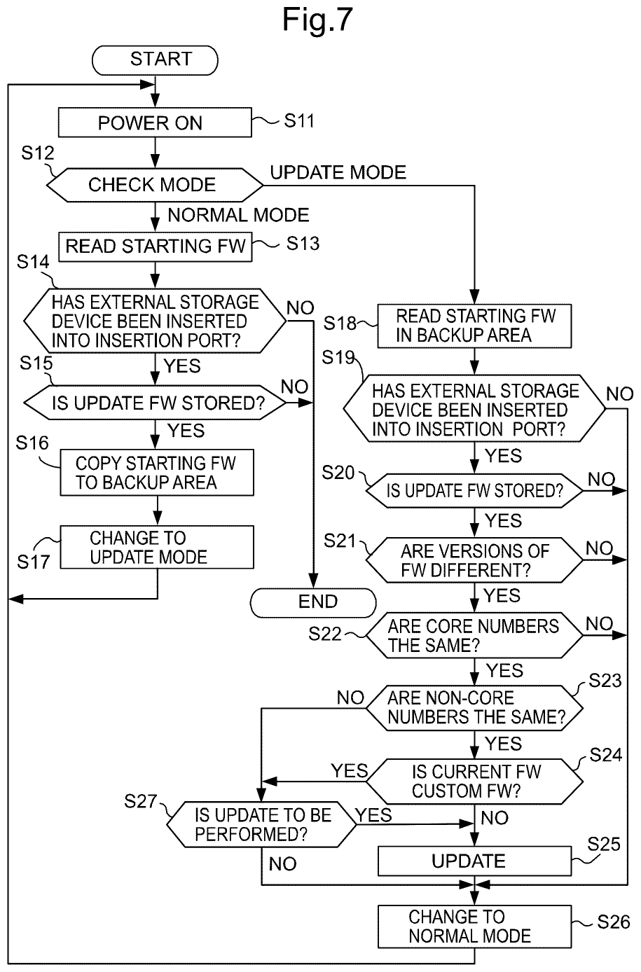

FIG. 7 is a flowchart illustrating a flow of an update process according to the present embodiment. When the image forming apparatus 1 is powered on (Step S11), the controller 111 checks a starting mode of the image forming apparatus 1 (Step S12). In general, the starting mode is set to a normal mode (a mode in which the image forming apparatus 1 is started normally). When the starting mode is the normal mode (Step S12: normal mode), the controller 111 reads and execute firmware FW1 from the nonvolatile memory 112 (Step S13).

The controller 111 checks whether an external storage device 3 is inserted into the external storage connection device 17 (Step S14). When the external storage device 3 is inserted (Step S14: YES), the controller 111 checks whether the external storage device 3 is storing update firmware (Step S15).

When the external storage device 3 is storing update firmware (Step S15: YES), the controller 111 copies the firmware FW1 in the nonvolatile memory 112 to a backup area of the nonvolatile memory 112 (Step S16).

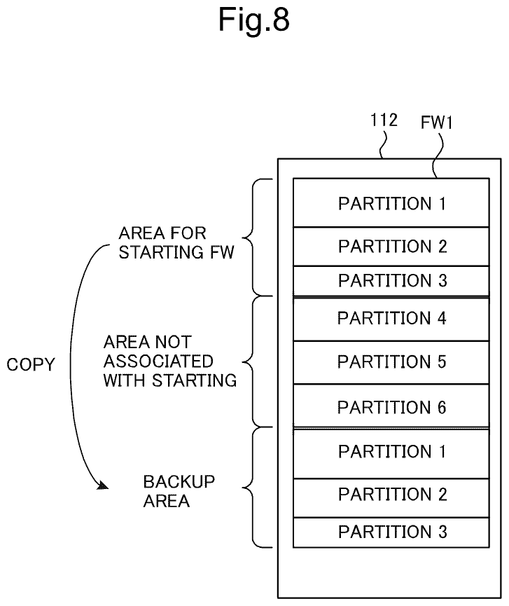

FIG. 8 is a diagram illustrating a data structure in the nonvolatile memory 112. When the firmware FW1 is updated, the controller 111 first copies details affecting starting to the backup area. In preparation of a case in which an unexpected situation such as a situation in which the image forming apparatus 1 is suddenly powered off occurs while updating the firmware FW1 and the update is not performed normally, the controller 111 backs up details affecting starting in the firmware FW 1 before the update is performed.

Subsequently, the controller 111 changes the starting mode to an update mode (Step S17), restarts the image forming apparatus 1, and performs the process of Step S11. The update mode is a mode in which firmware is updated.

When an external storage device 3 is not inserted into the external storage connection device 17 (Step S14: NO) and when update firmware is not stored in the external storage device 3 (Step S15: NO), the controller 111 executes firmware of the functions (such as a copier) and starts the image forming apparatus 1 in a normally operable state.

When it is determined in Step S12 that the starting mode is the update mode as a result of checking the mode in the controller 111 (Step S12: update mode), the controller 111 reads and executes the firmware FW1 stored in a backup area of the nonvolatile memory 112 (Step S18).

The controller 111 checks whether an external storage device 3 is inserted into the external storage connection device 17 (Step S19). When an external storage device 3 is inserted (Step S19: YES), the controller 111 checks whether update firmware is stored in the external storage device 3 (Step S20).

When update firmware is stored in the external storage device 3 (Step S20: YES), the controller 111 compares a version of the firmware FW1 stored in the nonvolatile memory 112 with a version of the update firmware (Step S21).

When both versions are different (Step S21: YES), the controller 111 compares the management numbers (core numbers) of areas affecting starting in the firmware FW1 stored in the nonvolatile memory 112 and the update firmware (Step S22).

For example, when the update firmware is the firmware FW2 illustrated in FIG. 4, the core number of the update firmware is different from the core number of the firmware FW1 (Step S22: NO). In this case, the controller 111 does not update the firmware FW1 and changes the mode to the normal mode (Step S26). After Step S26, the controller 111 performs the process of Step S11.

For example, when the update firmware is the firmware FW3 illustrated in FIG. 5, the core number of the update firmware is the same as the core number of the firmware FW1 (Step S22: YES), and thus the controller 111 compares the management numbers (non-core numbers) of areas not affecting starting (Step S23).

When both non-core numbers are different like the firmware FW1 and the firmware FW3, there is a likelihood that data in the area not affecting starting will disappear if update is performed in this state.

Therefore, in order for a user to ascertain whether update is to be performed, the controller 111 displays a selection screen for inquiring about whether update is to be performed on the display device 121 when the controller 111 determines that both non-core numbers are different like the firmware FW1 and the firmware FW3 (Step S23: NO).

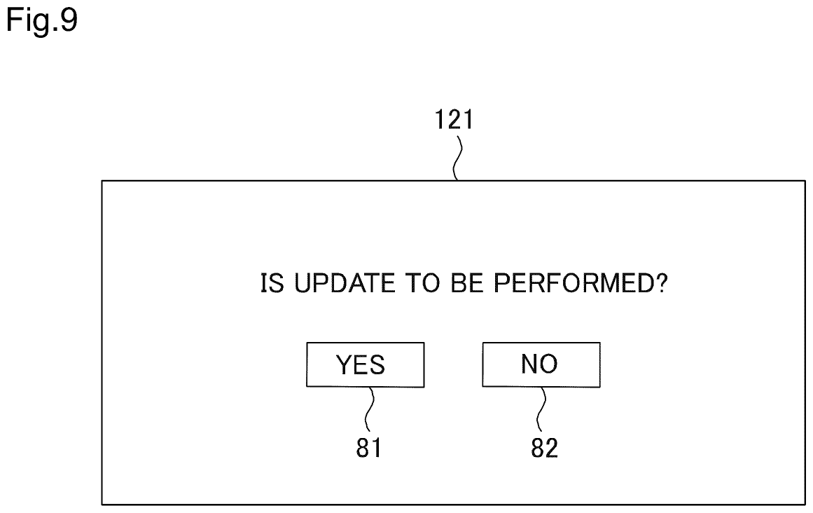

FIG. 9 is a diagram illustrating a display example of the display device 121 at the time of displaying of the selection screen. When the user operates a button 81 indicating “YES” and an update execution instruction is input to the input receiving device 12 via the touch panel (Step S27: YES), the controller 111 determines that update is to be performed and overwrites an area in which the firmware FW1 is stored in the nonvolatile memory 112 with the firmware FW3 (Step S25). Subsequently, the controller 111 changes the mode to the normal mode (Step S26). After Step S26, the controller 111 performs the process of Step S11.

When the user operates a button 82 indicating “NO” and an update non-execution instruction is input to the input receiving device 12 via the touch panel (Step S27: NO), the controller 111 determines that update is not to be performed and changes the mode to the normal mode (Step S26). After Step S26, the controller 111 performs the process of Step S11.

The firmware includes custom firmware having a special function or the like. When the controller 111 determines that both non-core numbers are the same like the firmware FW1 and the firmware FW3 (Step S23: YES), the controller 111 determines whether the firmware FW1 in the nonvolatile memory 112 is custom firmware (Step S24).

When it is determined that the firmware FW1 in the nonvolatile memory 112 is custom firmware (Step S24: YES), the controller 111 causes the display device 121 to display the selection screen for inquiring about whether update is to be performed as illustrated in FIG. 9. That is, when core number of the firmware FW1 is the same as the core number of the update firmware but the firmware FW1 is custom firmware, the controller 111 displays the selection screen for inquiring about whether update is to be performed to a user.

When the user operates the button 81 indicating “YES” and an update execution instruction is input to the input receiving device 12 via the touch panel (Step S27: YES), the controller 111 determines that update is to be performed and overwrites the area in which the firmware FW1 is stored in the nonvolatile memory 112 with the firmware FW3 stored in the external storage device 3 (Step S25). Subsequently, the controller 111 changes the mode to the normal mode (Step S26). After Step S26, the controller 111 performs the process of Step S11.

When the user operates the button 82 indicating “NO” and an update non-execution instruction is input to the input receiving device 12 via the touch panel (Step S27: NO), the controller 111 determines that update is not to be performed and changes the mode to the normal mode (Step S26). After Step S26, the controller 111 performs the process of Step S11.

When an external storage device 3 is not inserted into the external storage connection device 17 (Step S19: NO), when update firmware is not stored in an external storage device 3 (Step S20: NO), or the version of the firmware FW1 and the version of the update firmware are the same (Step S21: NO), the controller 111 does not update the firmware FW1 and changes the mode to the normal mode (Step S26). After Step S26, the controller 111 performs the process of Step S11.

The ROM storing firmware is divided into a plurality of partitions and stores data. A partition structure may vary according to a version of the firmware, and there is a problem in that the apparatus does not operate correctly particularly when the partition structure of firmware affecting starting of the apparatus varies.

That is, the partition structure of the firmware stored in the ROM needs to be considered in updating the firmware, but this point is not mentioned in the first technique and the second technique described above.

On the other hand, according to the present embodiment, when firmware stored in the nonvolatile memory 112 is updated with newest firmware, the core numbers indicating the partition structures thereof are compared, and update is determined not to be performed when both core numbers are different. As a result, it is possible to prevent failure of update of firmware and to avoid update with details not intended by the user.

In the present embodiment, when the core number of the firmware stored in the nonvolatile memory 112 and the core number of the newest firmware are the same (the partition structures of the areas affecting starting are the same) but the non-core numbers thereof are different (the partition structures of the areas not affecting starting are different) and the firmware stored in the nonvolatile memory 112 is custom firmware, a user is caused to ascertain whether update is to be performed. Accordingly, it is possible to avoid update with details not intended by the user.

While the present disclosure has been described in detail with reference to the embodiments thereof, it would be apparent to those skilled in the art the various changes and modifications may be made therein within the scope defined by the appended claims.

What is claimed is:

1. An image processing apparatus comprising:
a storage device including a plurality of partitions and storing firmware;
a controller including a processor and performing update of the firmware by causing the processor to execute a control program; and
a data acquiring device acquiring update firmware,
wherein each of the firmware and the update firmware includes a management number corresponding to a partition in which firmware associated with starting is stored as a core number, and
wherein the controller compares the core number of the firmware stored in the storage device with the core number of the update firmware and performs a process of overwriting an area in which the firmware is stored in the storage device with the update firmware when both core numbers match.

2. The image processing apparatus according to claim 1, further comprising an input receiving device receiving a user's instruction,
wherein each of the firmware and the update firmware further includes a management number corresponding to a partition in which firmware not associated with starting is stored as a non-core number, and
wherein the controller compares the core number and the non-core number of the firmware stored in the storage device with the core number and the non-core number of the update firmware and performs a process of overwriting an area in which the firmware is stored in the storage device with the update firmware when both core numbers match, both non-core numbers do not match, and an input indicating overwriting permission is received by the input receiving device.

3. The image processing apparatus according to claim 1, further comprising an input receiving device receiving a user's instruction,
wherein the controller performs a process of overwriting an area in which the firmware is stored in the storage device with the update firmware when the firmware stored in the storage device is custom firmware and an input indicating overwriting permission is received by the input receiving device.

4. The image processing apparatus according to claim 3, further comprising a display device,
wherein the controller causes the display device to display a selection screen for inquiring about whether the firmware is to be updated when the firmware stored in the storage device is custom firmware.

5. A firmware update method comprising:
a storage step of storing firmware in a storage device including a plurality of partitions;
a data acquiring step of acquiring update firmware via a data acquiring device;
each of the firmware and the update firmware including a management number corresponding to a partition in which firmware associated with starting is stored as a core number,
a comparison step of comparing the core number of the firmware stored in the storage device with the core number of the update firmware; and
an overwriting step of overwriting an area in which the firmware is stored in the storage device with the update firmware when it is determined in the comparison step that the core number of the update firmware and the core number of the firmware match.
